(19) United States
(12) Patent Application Publication
(10) Pub. No.: US 2023/0029903 A1
(43) Pub. Date: Feb. 2, 2023

(54) REFERENCE RESOURCE FOR UPLINK CANCELLATION IN NR-U

(71) Applicant: TELEFONAKTIEBOLAGET LM ERICSSON (PUBL), STOCKHOLM (SE)

(72) Inventors: Bikramjit Singh, RAASEPORI (FI); Alexey Shapin, LULEÅ (SE); Ali Behravan, STOCKHOLM (SE); Mai-Anh Phan, HERZOGENRATH (DE); Sorour Falahati, STOCKHOLM (SE); Abdulrahman Alabbasi, KISTA (SE)

(21) Appl. No.: 17/798,288

(22) PCT Filed: Feb. 5, 2021
(86) PCT No.: PCT/IB2021/050971

§ 371 Date: Aug. 8, 2022

Related U.S. Application Data
(60) Provisional application No. 62/971,691, filed on Feb. 7, 2020.
(60) Provisional application No. 62/976,773, filed on Feb. 14, 2020.

(51) Int. Cl. H04W 72/12; H04W 76/28

(52) U.S. Cl. CPC H04W 72/1268; H04W 76/28; H04W 74/0808

(57) ABSTRACT

Systems and methods for uplink cancellation are provided. In some embodiments, a method performed by a wireless device for performing uplink cancellation includes receiving an indication to stop a transmission; and receiving an indication to transmit on cancelled uplink resources. In some embodiments, in response to receiving the indication to stop the transmission, performing one of: cancelling the transmission; and muting the transmission. In this way, the New Radio (NR) Uplink (UL) cancellation mechanism can be enabled on NR-Unlicensed (NR-U) resources and helps to cater Ultra-Reliable and Low Latency Communication (URLLC) services.

### RELATED APPLICATIONS

This application claims the benefit of U.S. Provisional Patent No. 62/971,691, filed Feb. 7, 2020, and U.S. Provisional Patent No. 62/976,773, filed Feb. 14, 2020, the disclosures of which are hereby incorporated herein by reference in their entireties.

### TECHNICAL FIELD

The present disclosure relates to uplink cancellation.

### BACKGROUND

Ultra-reliable and low latency communication (URLLC) is one of the main use cases of 5G New Radio (NR). URLLC has strict requirements on transmission reliability and latency, i.e., 99.9999% reliability within 1 ms one-way latency. In NR Rel-15, several new features and enhancements were introduced to support these requirements. In Rel-16, standardization works are focused on further enhancing URLLC system performance as well as ensuring reliable and efficient coexistence of URLLC and other NR use cases. One example scenario is when both Enhanced Mobile Broadband (eMBB) and URLLC User Equipments (UEs) co-exist in the same cell. Here, mainly two approaches have been identified to support multiplexing/prioritization.

### UL Cancellation in NR

The first method is based on power control to increase the power of the URLLC to make it more resilient to interference from the eMBB user(s). Additional power control for release 16 UEs are specified in 3GPP TS 38.213, 7.1.1. The main advantage with this option is that it does not require any changes in the behavior of the eMBB UE; hence it works with Release 15 UEs. One disadvantage is that to guarantee the performance of the URLLC UE while being interfered by eMBB traffic, the transmit Power Spectral Density (PSD) may have to be increased significantly which can cause interference to other cells. Also, UEs not in the close vicinity of the base station may not have the power budget to do this increase and will therefore experience much lower Signal to Interference and Noise Ratio (SINR) than the required.

The second method is based on a cancellation indicator being transmitted from the base station to the interfering eMBB UEs. When a URLLC UE is scheduled on time/frequency resources that are already scheduled to a lower priority eMBB UE, the base station can transmit a cancellation indicator to the eMBB UE. Upon reception of this indicator the eMBB UE will avoid transmitting on a set of preconfigured resources. The details of the cancellation indicator, and the UE behavior upon reception of this signal, is specified in 3GPP TS 38.213.

The mechanism for Uplink (UL) Cancellation Indication (CI) includes a reference time-frequency region that is configured for the UE by Radio Resource Configuration (RRC) signaling, and a Downlink Control Information (DCI) that indicates parts of the configured resources within which the transmission should be cancelled. The reference time-frequency region is also referred to as Reference Resource (RR). The size of the cancellation indication DCI, as well as the time domain granularity, is configurable. The frequency domain granularity can then be determined from the total bit field size and the time domain granularity.

A typical use case for this is when eMBB traffic is scheduled in a whole slot and all

Physical Resource Blocks (PRBs) and time sensitive URLLC needs to be transmitted. Here, time sensitive means that it requires instant access to the channel and waiting until the next slot before transmission will introduce too much delay. In NR, URLLC traffic maybe be scheduled on one or a few Orthogonal Frequency Division Multiplexing (OFDM) symbols and with a significantly shorter time from the uplink grant to when the uplink transmission takes place. This means that eMBB users may already have been scheduled on all available time/frequency resources. With the cancellation indicator, the gNB can choose to cancel the eMBB traffic and hence reduce the interference to the URLLC UE.

### NR-U

In addition to operation in licensed bands, NR has been enhanced in 3GPP Rel-16 (RP-190706, Revised WID on NR-based Access to Unlicensed Spectrum) to allow operation in unlicensed bands, i.e., NR-Unlicensed (NR-U). Allowing unlicensed networks, i.e., networks that operate in unlicensed or shared spectrum to effectively use the available spectrum is an attractive approach to increase system capacity. For convenience, unlicensed spectrum is used herein to refer to both unlicensed and shared spectrum.

Although unlicensed spectrum does not match the qualities of the licensed regime, solutions that allow an efficient use of it as a complement to licensed deployments have the potential to bring great value to the 3GPP operators, and, ultimately, to the 3GPP industry as a whole. Some features in NR need to be adapted to comply with the special characteristics of the unlicensed band as well as also different regulations. Further, if a UE intended to use unlicensed spectrum, it may employ Clear Channel Assessment (CCA) schemes to find out whether the channel is free or not over a certain period. One such technique is Listen Before Talk (LBT). There are many different flavors of LBT, depending on which channel access mode the device uses and which type of data it wants to transmit in the upcoming transmission opportunity, referred to as Channel Occupancy Time (COT). Common for all flavors is that the sensing is done in a particular channel (corresponding to a defined carrier frequency) and over a predefined bandwidth. Further, two modes of access operations are defined—Frame-Based Equipment (FBE) and Load-Based Equipment (LBE). In FBE mode, the sensing period is simple, while the sensing scheme in LBE mode is more complex.

### Semi-Static Channel Occupancy (FBE Mode)

In FBE mode as defined in 3GPP and illustrated in FIG. 1, the gNB assigns Fixed Frame Periods (FFP)s, senses the channel for 9 microseconds (μs) just before the FFP boundary, and if the channel is sensed to be free, it starts with a downlink transmission, and allocates resources among different UEs in the FFP. This procedure can be repeated with a certain periodicity. In the FFP, DL/UL transmissions are only allowed within the COT, a subset of FFP resource, where the remaining Idle period is reserved so that other nodes also have the chance to sense and utilize the channel. Hence in FBE operations, the channel is sensed at specific intervals just before the FFP boundary. The FFP can be set to values between 1 and 10 ms and can be changed after a minimum of 200 ms. The IDLE period is a regulatory requirement and is supposed to be at least TIDLE≥max(0.05*COT, 100 μs). In 3GPP TS 37.213 this has been simplified to be TIDLE=max(0.05*FFP, 100 μs), i.e., the maximum channel occupancy time, MCOT, would be defined as TMCOT=min(0.95*FFP, FFP-0.1 ms). So for 10 ms FFP, the MCOT would be 9.5 ms, while for 1 ms FFP the MCOT would be 0.9 ms=0.9*FFP.

There currently exist certain challenge(s). The cancellation techniques described in the previous section are standardized for NR considering the operation on licensed spectrum. The same techniques can be utilized for NR-U where NR is operating on unlicensed spectrum. However, this may require some modification as NR-U stipulates LBT, i.e., a sensing mechanism before any transmission.

### SUMMARY

Systems and methods for uplink cancellation are provided. In some embodiments, a method performed by a wireless device for performing uplink cancellation includes receiving an indication to stop a transmission; and receiving an indication to transmit on cancelled uplink resources. In some embodiments, in response to receiving the indication to stop the transmission, performing one of: cancelling the transmission; and muting the transmission. In this way, the NR UL cancellation mechanism can be enabled on NR-U resources and helps to cater URLLC services.

In some embodiments, in NR-U operation, the UL cancellation can happen on any subset of a set of resources called reference resources, where the reference resources are meant for UL transmission.

Some embodiments of the current disclosure explore how UL cancellation can be performed in various scenarios without violating the sensing requirement in NR-U. In some embodiments, these reference resources should exclude resources marked for IDLE period, LBT resources, or DL transmission (as these resources are not meant for UL transmission). This is discussed in detail with examples below.

Certain embodiments may provide one or more of the following technical advantage(s). The present disclosure relates to enabling the NR UL cancellation mechanism on NR-U resources and helps catering URLLC services.

In some embodiments, receiving the indication to stop the transmission comprises: receiving the indication to stop the transmission from a base station. In some embodiments, the indication to stop the transmission comprises a Downlink Control Information (DCI).

In some embodiments, the indication to transmit on cancelled uplink resources acts like a normal grant. In some embodiments, in response to receiving the indication to transmit on cancelled uplink resources, determining whether Listen Before Talk (LBT) is needed or required.

In some embodiments, whether LBT is needed or required depends on the time-gap between the latest transmission from the base station and the cancelled uplink resources. In some embodiments, the indication to stop the transmission is a Cancellation Indicator (CI) that indicates a Reference Resource (RR).

In some embodiments, any of the steps consider LBT specific procedures to make time granularity of CI more accurate. In some embodiments, if the RR spans over more than one Fixed Frame Period (FFP) determining to apply one or several options.

In some embodiments, the one or several options comprises one or more of the group consisting of: the RR starts from the beginning of the frame period; the RR ends in the end of the current frame period; and the RR ends in the end of the current FFP minus defined IDLE period.

In some embodiments, the defined IDLE period is a maximum of: 100 μs and 5% of FFP or 5% of Channel Occupancy Time (COT). In some embodiments, the indication to stop the transmission comprises a row ID of a table that is mapped (e.g., bit-map) to the resource to be cancelled indicated by the given row ID of the table.

In some embodiments, the RR excludes all pauses and gaps introduced by unlicensed operation (e.g., gaps for LBT within the COT, IDLE periods etc.). In some embodiments, the RR includes all pauses and gaps introduced by unlicensed operation (e.g., gaps for LBT within the COT, IDLE periods etc.).

In some embodiments, the wireless device can know IDLE periods allocation though broadcast/unicast messaging indicating FFP configuration; and/or the wireless device can be informed about LBT gaps explicitly.

In some embodiments, the RR spans across multiple FFPs. In some embodiments, in response to receiving the indication stop the transmission, transmitting the transmission after cancelled resource in the same or another COT.

In some embodiments, if the wireless device is scheduled to perform repetitions (or multi-segment transmission) and the wireless device receives CI with indicated reference resource, then one or more of the following options can happen: the repetitions which intersect the reference resource and the following repetitions will be cancelled; and all the repetitions (repetitions that intersect reference resource and the repetitions that don't intersect the reference resource) will be cancelled.

In some embodiments, the configuration of RR, including time and frequency regions and the time and frequency granularities, are adapted to the FFP or maximum COT. In some embodiments, the duration of the reference region in the time domain is set to be at most equal to maximum COT in the cell.

In some embodiments, the monitoring occasions for uplink cancellation are adapted to FFP and/or Maximum Channel Occupancy Time (MCOT); e.g., IDLE periods following the MCOT are excluded from monitoring. In some embodiments, any of these can be enabled/disabled by higher layer signaling; e.g., Radio Resource Control (RRC) or Medium Access Control (MAC), Control Element (CE) signals.

In some embodiments, the CI transmission behavior includes one or more of: CI is transmitted in the beginning of COT; CI is transmitted in the other part of the COT where the first transmission in the COT is not CI; CI is not transmitted in the Uplink, UL, symbols, or IDLE periods, or LBT gaps in the COT; CI is always transmitted in the same COT for which UL transmissions are to be cancelled, e.g., both CI transmissions and cancelled UL transmissions occur in the same COT; and CI is sent to cancel UL transmissions of successive COTs, e.g., CI transmission and cancelled UL transmissions occur in different COTs.

In some embodiments, when CI is transmitted in the beginning of COT, LBT is required. In some embodiments, when CI is transmitted in the other part of the COT where the first transmission in the COT is not CI, LBT is not required.

In some embodiments, in response to receiving the indication to stop the transmission, sending non-critical or deprioritize data on the remaining un-cancelled transmission resource. In some embodiments, if the uplink resources contain a PDU which has a critical MAC CEs, the wireless device, upon reception of such cancelling/muting signal should retrigger such control element at the next available transmission. In some embodiments, the critical MAC CE is one of: a confirmation message; a Common Control Channel; a Buffering Status Report; and Power Headroom Report. In some embodiments, the method also includes: adapting the delayed control element to suit the next transmission.

In some embodiments, in response to receiving the indication to stop the transmission, the wireless device performs one or more of: retrigger or postpone the configuredGrantTimer, to enable more time for retransmission; restart the configuredGrantRetxTimer; and stop the configuredGrantRetxTimer, and the timer is enabled by re-transmitting in the next available grant.

In some embodiments, receiving the indication to transmit on cancelled uplink resources further comprises an indication of whether LBT needs to be performed before the resource granted for UL data transmission.

In some embodiments, receiving the indication to transmit on cancelled uplink resources further comprises an LBT category. In some embodiments, the LBT category is agreed to in advance for cancellation cases.

In some embodiments, receiving the indication to transmit on cancelled uplink resources further comprises an indication to monitor “LBT success” signaling before the transmission on the cancelled resource.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an FBE mode as defined in 3GPP;

FIG. 2 illustrates one example of a cellular communications system in which embodiments of the present disclosure may be implemented;

FIG. 3 illustrates a method performed by a wireless device for performing uplink cancellation, according to some embodiments of the current disclosure;

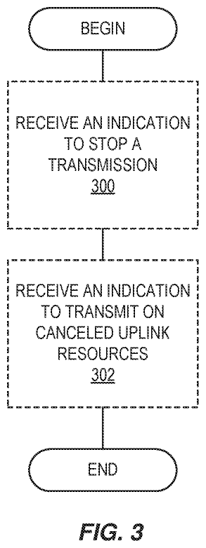

FIG. 4 illustrates a UL cancellation procedure with three options, according to some embodiments of the current disclosure;

FIG. 5 illustrates the duration of the IDLE period can be derived either from system parameters or from regulation rules for a specific band, according to some embodiments of the current disclosure;

FIG. 6 illustrates that the reference resource can exclude all pauses and gaps introduced by unlicensed operation (gaps for LBT within the COT, IDLE periods etc.), according to some embodiments of the current disclosure;

FIG. 7 illustrates that the CI is transmitted in the beginning of COT, according to some embodiments of the current disclosure;

FIG. 8 is a schematic block diagram of a radio access node according to some embodiments of the present disclosure;

FIG. 9 is a schematic block diagram that illustrates a virtualized embodiment of the radio access node according to some embodiments of the present disclosure;

FIG. 10 is a schematic block diagram of the radio access node according to some other embodiments of the present disclosure;

FIG. 11 is a schematic block diagram of a wireless communication device according to some embodiments of the present disclosure;

FIG. 12 is a schematic block diagram of the wireless communication device according to some other embodiments of the present disclosure;

FIGS. 13 and 14 illustrate a communication system includes a telecommunication network according to some other embodiments of the present disclosure; and

FIGS. 15, 16, 17, and 18 are flowcharts illustrating a method implemented in a communication system according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

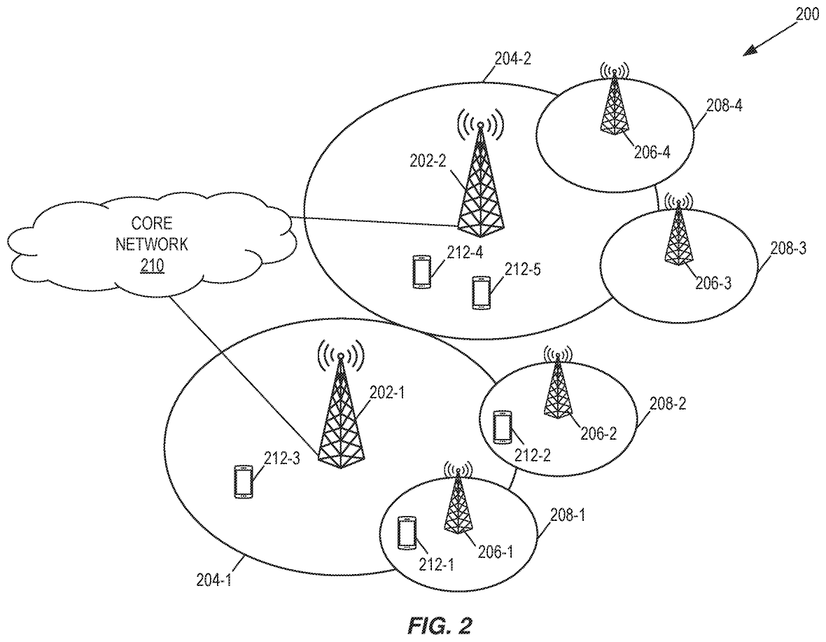

FIG. 2 illustrates one example of a cellular communications system 200 in which embodiments of the present disclosure may be implemented. In the embodiments described herein, the cellular communications system 200 is a 5G system (5GS) including a NR RAN. In this example, the RAN includes base stations 202-1 and 202-2, which in 5G NR are referred to as gNBs (e.g., Long Term Evolution (LTE) RAN nodes connected to SGC, which are referred to as gn-eNBs), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G core (5GC). The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

The cancellation techniques described above are standardized for NR considering the operation on licensed spectrum. The same techniques can be utilized for NR-Unlicensed (NR-U) where NR is operating on unlicensed spectrum. However, this may require some modification as NR-U stipulates LBT, i.e., a sensing mechanism before any transmission.

Systems and methods for uplink cancellation are provided. In some embodiments, a method performed by a wireless device for performing uplink cancellation includes receiving an indication to stop a transmission; and receiving an indication to transmit on cancelled uplink resources. In some embodiments, in response to receiving the indication to stop the transmission, performing one of: cancelling the transmission; and muting the transmission. In this way, the New Radio (NR) Uplink (UL) cancellation mechanism can be enabled on NR-U resources and helps to cater Ultra-Reliable and Low Latency Communication (URLLC) services.

In some embodiments, the wireless device receives an indication to stop a transmission (step 300). In some embodiments, the wireless device receives an indication to transmit on cancelled uplink resources (step 302). In some embodiments, both are received.

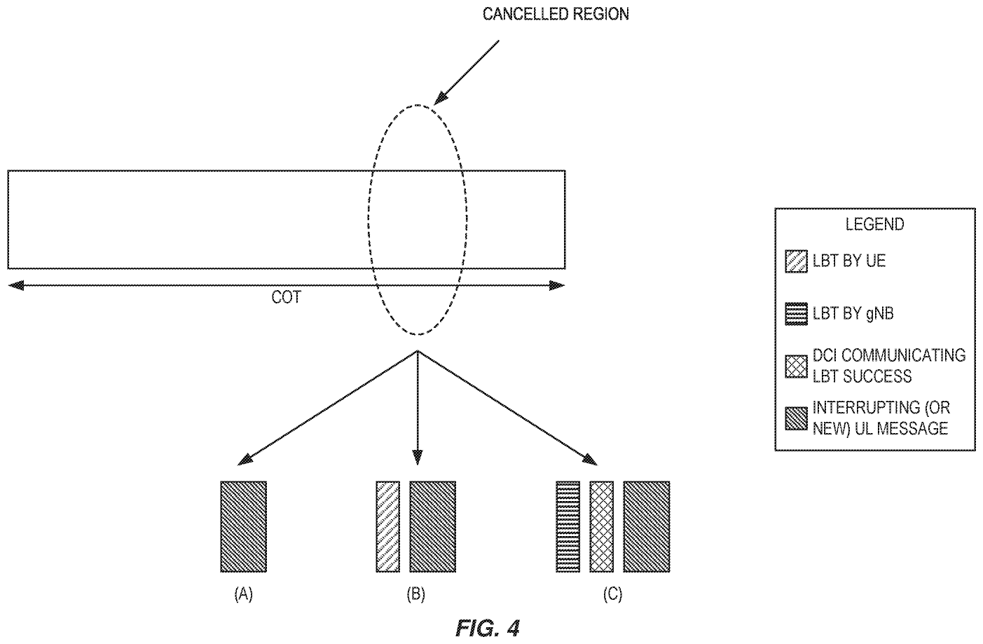

An UL cancellation procedure is depicted in FIG. 4 with three options: scenario A, scenario B, and scenario C. In FIG. 4, scenario A shows where an UL transmission is cancelled, and a new transmission is allowed without an additional need for LBT. This could happen if prior to this new transmission, either gNB or this UE is already transmitting in the vicinity where, e.g., the time-gap is less than 16 μs. Further, in some scenarios, where the cancelled transmission and new transmission belong to same UE, additional LBT may not be needed. In FIG. 4, options B and C show that, if the time-gap is larger than 16 μs, then LBT is required before the transmission. In scenario B, LBT is performed by the UE itself and in scenario C, gNB performs the LBT and indicates the LBT success to the UE through DCI or some reference signals.

In the cancellation process, the following action types (or signaling) can be involved:

1. Cancellation indicator: gNB indicates to a UE or group of UEs by means of a DCI to stop their transmission(s). There are two ways, these transmissions can be interrupted—either the transmission is cancelled or muted (power is reduced).

2. Cancelled resource grant: In this signaling, gNB indicates to a UE to transmit on cancelled UL resources. In some cases, this grant may act like a normal grant. For the granted UL resource (which is allocated for new transmission, see FIG. 4), LBT may or may not be needed, depending on the time-gap between the gNB's latest transmission and the UE's granted UL resource. The cancelled resource and granted resource can belong to the same UE or different UEs.

In some embodiments, both signaling, i.e., 1 and 2 above, can be transmitted jointly or separately in any order, irrespective of NR spectrum scenarios being licensed or unlicensed.

In some embodiments disclosed herein, at least action (or signaling) 1 is utilized/done alone; or action 1 is done/combined together with action 2.

### Cancellation Indicator (CI)

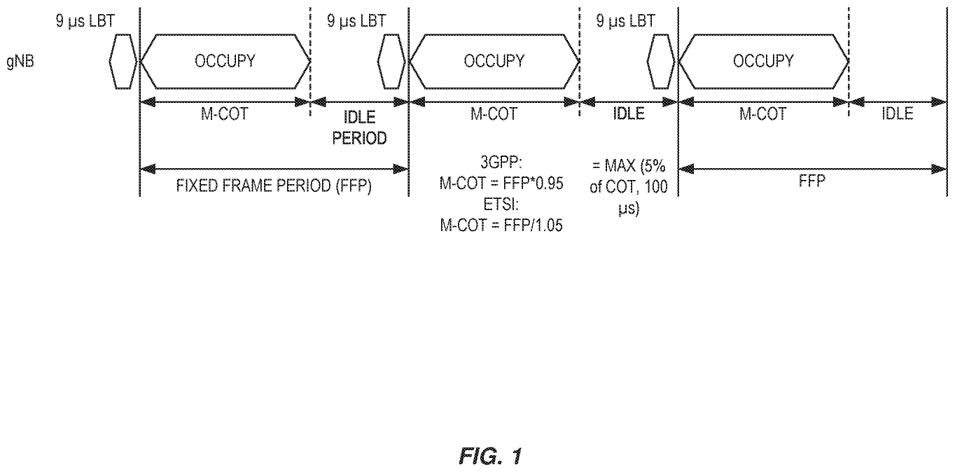

Certain resources cannot be used for transmission, e.g., resources in the IDLE period during the end of FFP (see FIG. 1). Therefore, the procedure for a reference resource, RR, (which is indicated by CI) determination should now consider LBT specific procedures to make time granularity of CI more accurate. It is logical that Rel-16 way of determination of reference resource start can be reused in some cases, i.e., reference resource starts after T_{proc,2} (Physical Uplink Shared Channel (PUSCH) processing capability 2, TS 38.213) after the end of PDCCH carrying CI. Further determination of RR can further be optimized for unlicensed. There can be several embodiments:

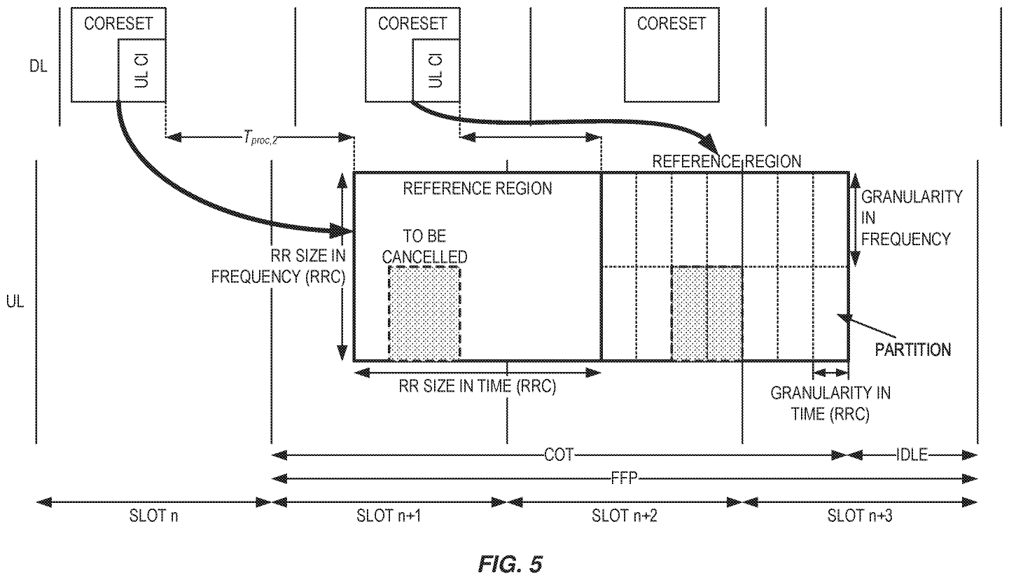

If the reference resource spans over more than one FFP, one or several options can be applied: Reference resource starts from the beginning of frame period; Reference resource ends in the end of current frame period; or Reference resource ends in the end of current FFP minus defined IDLE period, e.g., maximum of 100 μs and 5% of FFP or 5% of COT. In some embodiments, the defined IDLE period may have a determined maximum of between 80 and 120 μs. For usage in 3GPP, 5% of FFP is recommended, but other percentages (such as 3, 4, 6, 7, 10%, etc.) may be used in some embodiments. The duration of the IDLE period can be derived either from system parameters or from regulation rules for a specific band, see FIG. 5.

Regarding LBT resources, the FFP length can vary, hence the periodicity of idle time resource can change accordingly, e.g., idle time for 1 ms FFP length would be much more frequent than 10 ms FFP, but also shorter. Hence, a gNB can create a table for allowed resources for cancellation which can depend on what FFP length gNB is utilizing. For example, if a gNB has the ability to allocate three types of FFP lengths—1 ms or 2 ms or 10 ms for allocation purposes, then it will create three tables in its database that stores the allowed resources for cancellation (because the “idle time” periodicity or occurrences for different FFPs would be different, and these idle time resources would be excluded from the table). Alternatively, the tables can be “constructed” on the fly, and the reference resource configuration is signaled to the UE via RRC, which would however require significantly higher signaling overhead.

Cancellation indication: Whenever a gNB intends to cancel already assigned allocation, it can send a row ID of the table in a cancellation indicator (which could be DCI or a RRC message) that is mapped (bit-map) to the resource to be cancelled indicated by the given row ID of the table.

Further, the FFP length can change after 200 ms, so another table is used delineating the exclusion of resources correspond to IDLE time period.

In another embodiment, the excluded resources can be resources where LBT is performed. The LBT resources can be categorized in two classes: (a) The LBT resources which are in the IDLE period which are at the end of the FFP; and/or (b) The LBT resources which may occur during the COT, where COT is a sub-set resource of FFP, e.g., in 3GPP Rel-16 spec, the value is 95%.

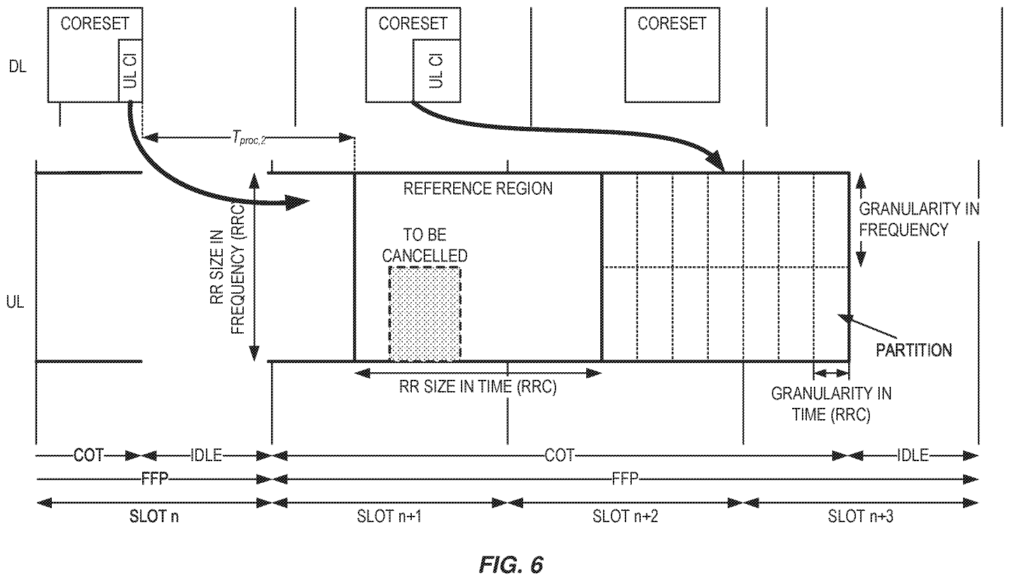

In one embodiment, the reference resource can exclude all pauses and gaps introduced by unlicensed operation (gaps for LBT within the COT, IDLE periods etc.), see FIG. 6.

In one embodiment, the reference resource can include all pauses and gaps introduced by unlicensed operation (gaps for LBT, IDLE periods etc.). For this, UE must be aware of these gaps and pauses, e.g., UE can know IDLE periods allocation though broadcast/unicast messaging indicating FFP configuration(s); and/or gNB can inform UE about LBT gaps explicitly.

In one embodiment, the case with FBE operation, reference resources can span across frame periods or FFPs. Several subcategories can be defined: LBT gaps in the COT can be excluded from a reference resource; and/or IDLE periods can be excluded from a reference resource.

In another embodiment, the excluded resources can be resources where symbols or slots are allocated for downlink transmission, for example, Downlink (DL) resources at the beginning of the frame boundary or other parts where the DL DCI including the CI and/or URLLC UL grant.

In one embodiment, it allows UE(s) with cancelled transmission to transmit after cancelled resource in the same or another COT.

In one embodiment, if a UE is scheduled to perform repetitions (or multi-segment transmission) and it receives CI with indicated reference resource, then following options can happen: The repetitions which intersect the reference resource and the following repetitions will be cancelled; and/or All the repetitions (repetitions that intersect reference resource and the repetitions that don't intersect the reference resource) will be cancelled.

In one embodiment, the configuration of reference resources, including time and frequency regions and the time and frequency granularities, are adapted to the FFP or maximum COT. As one example, the duration of the reference region in the time domain is set to be at most equal to maximum COT in the cell. The reason can be that e.g., a cancellation reference time beyond the maximum COT is not useful since the UE needs to be able to monitor at least one cancellation DCI, and therefore maximum COT must be larger than the monitoring periodicity. For example, a UE during a COT should be able to see at least one cancellation DCI, i.e., the periodicity of cancellation DCI should be smaller than the COT. Assuming that the reference time duration should be equal to monitoring periodicity, the reference time region should be adapted to e.g., maximum COT.

In another embodiment, the monitoring occasions for UL cancellation DCI is adapted to FFP and or Maximum COT (MCOT), i.e., e.g., IDLE periods following the MCOT are excluded from monitoring.

In one embodiment, the embodiments above can be enabled/disabled by higher layer signaling, i.e., RRC or MAC CE signals.

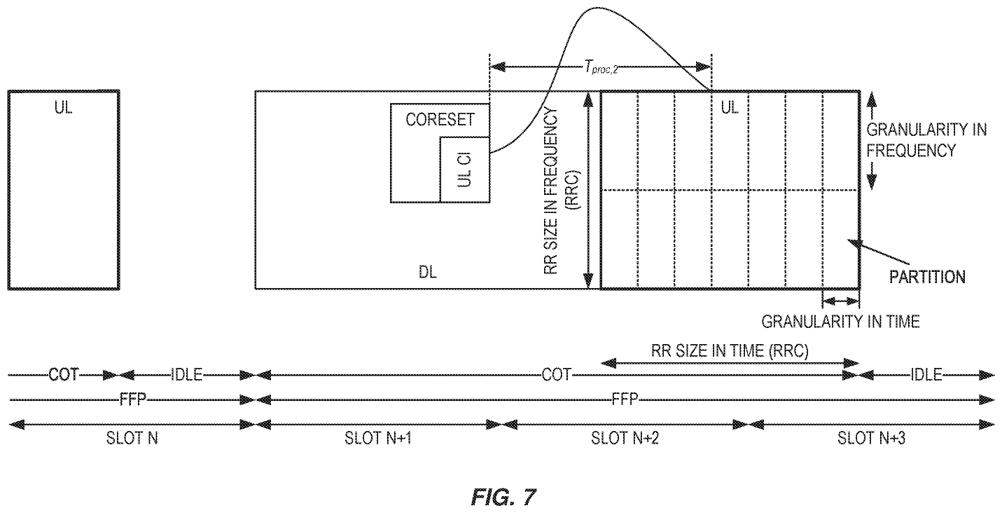

In one embodiment, the CI transmission behavior can be defined (below options can be combined): CI is transmitted in the beginning of COT, see FIG. 7, LBT is required; and/or CI is transmitted in the other part of the COT where the first transmission in the COT is not CI. In some scenarios, LBT is not required, e.g., if the gap with respect to the initiating Node is less than 16 μs, otherwise LBT is needed. In some embodiments, CI is not transmitted in the UL symbols, or IDLE periods, or LBT gaps in the COT. In some embodiments, CI is always transmitted in the same COT for which UL transmissions are to be cancelled, i.e., both CI transmissions and cancelled UL transmissions occur in the same COT. In some embodiments, CI is sent to cancel UL transmissions of successive COTs, i.e., CI transmission and cancelled UL transmissions occur in different COTs.

In an alternative embodiment, a gNB could send CI to let the UE know that this transmission or a part of this transmission is cancelled, hence the UE should send non-critical or deprioritize data on the remaining un-cancelled transmission resource.

In an alternative embodiment, if the uplink resources contain a PDU which has a critical MAC CEs, i.e., confirmation message or Common Control Channel; or a Buffering Status Report; or a Power Headroom Report, then the UE upon reception of such cancelling/or/muting signal should retrigger such control element at the next available transmission. In some embodiments, the UE should adapt the delayed control element to suit the next transmission.

For a Configured Grant, in various embodiments where a UE receives CI, underfollowing actions can be performed, e.g., UE should: retrigger or postpone the configuredGrantTimer, to enable more time for retransmission; restart the configuredGrantRetxTimer; and/or stop the configuredGrantRetxTimer, and the timer is enabled by re-transmitting in the next available grant.

### Cancelled Resource Grant

In one embodiment, the grant can indicate whether LBT needs to be performed before the resource granted for UL data transmission. Possibly in the scenarios with LBE, the LBT category can be indicated or agreed a priori for cancellation cases, see scenario B in FIG. 4.

In another embodiment, the grant will additionally ask UE to monitor “LBT success” signaling before the transmission on the cancelled resource. This means that the gNB takes responsibility for doing LBT, and if the LBT succeeds, then it is implicitly sends LBT success signaling (e.g., in the form of a DCI) to the UE for its UL transmission, see scenario C in FIG. 4, where the gNB has successfully occupied the channel and where it can share its COT with the UE.

### Idle Period Indication by Cancellation Indicator

Configurations of FFP periods can be same or different for different UEs where the UEs can also initiate the COT corresponding to the configured FFP, in addition to gNB. In such operations, determination of the idle periods depends on whether the device (gNB/UE) has initiated a COT and whether the FFPs for these devices are similar or not, with respect to starting time and duration.

Since the gNB is in control of all the DL and UL transmissions by scheduling or configuration of resources and manages the FFP parameters for FBE based mode operation, the gNB can determine the COT that each transmission corresponds to. Consequently, the gNB can determines an idle period that should be cleared from any DL or UL. To avoid UL transmission in this idle period, the gNB can use the Cancellation indicator signal to indicate to the UE a reference region that overlaps with the idle period. The reference region indicator can be a set of consecutive symbols, spanning over the channel bandwidth.

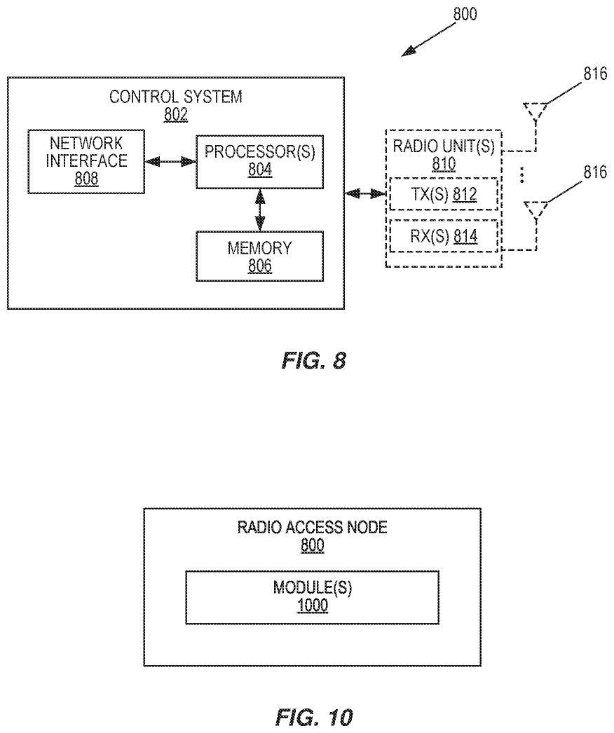

FIG. 8 is a schematic block diagram of a radio access node 800 according to some embodiments of the present disclosure. Optional features are represented by dashed boxes. The radio access node 800 may be, for example, a base station 202 or 206 or a network node that implements all or part of the functionality of the base station 202 or gNB described herein. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

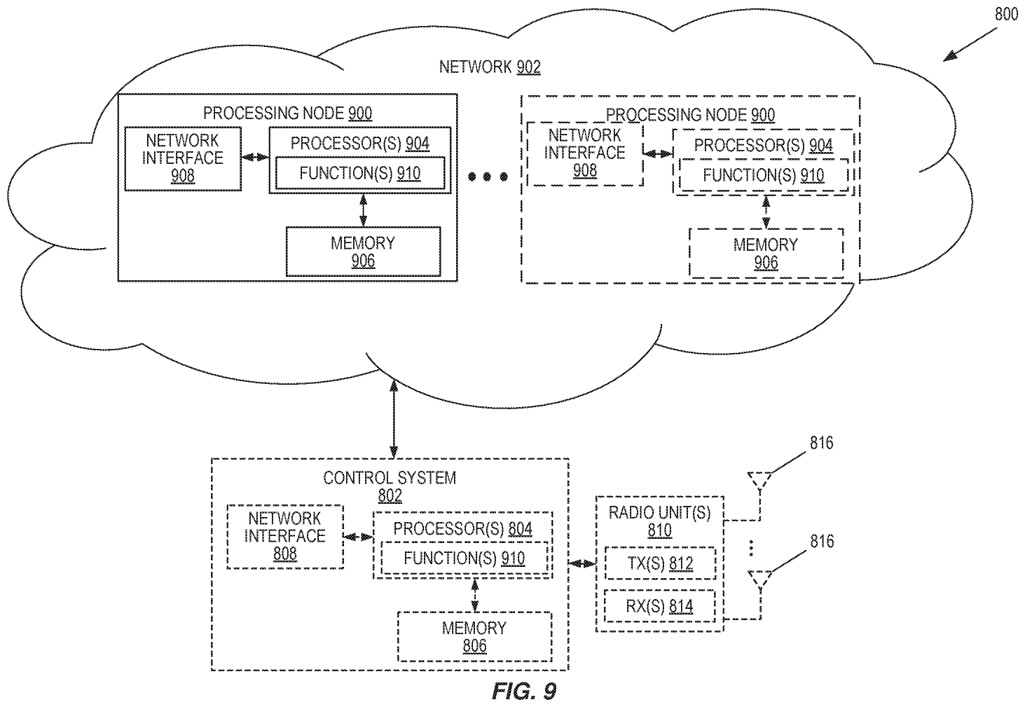

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 may include the control system 802 and/or the one or more radio units 810, as described above. The control system 802 may be connected to the radio unit(s) 810 via, for example, an optical cable or the like. The radio access node 800 includes one or more processing nodes 900 coupled to or included as part of a network(s) 902. If present, the control system 802 or the radio unit(s) are connected to the processing node(s) 900 via the network 902. Each processing node 900 includes one or more processors 904 (e.g., CPUs, ASICs, FPGAs, and/or the like), memory 906, and a network interface 908.

In this example, functions 910 of the radio access node 800 described herein are implemented at the one or more processing nodes 900 or distributed across the one or more processing nodes 900 and the control system 802 and/or the radio unit(s) 810 in any desired manner In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

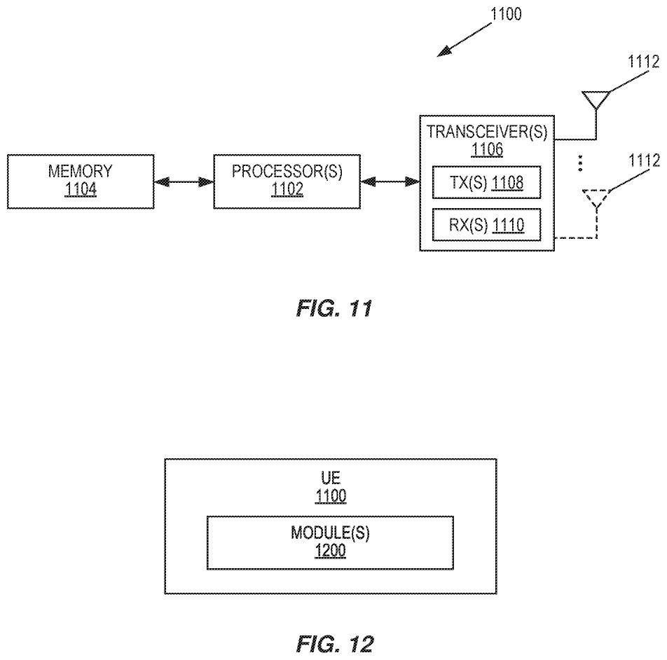

FIG. 10 is a schematic block diagram of the radio access node 800 according to some other embodiments of the present disclosure. The radio access node 800 includes one or more modules 1000, each of which is implemented in software. The module(s) 1000 provide the functionality of the radio access node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

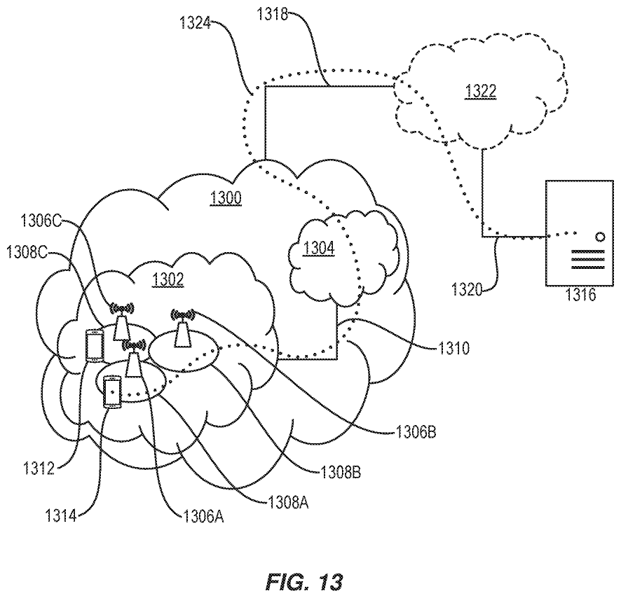

FIG. 11 is a schematic block diagram of a wireless communication device 1100 according to some embodiments of the present disclosure. As illustrated, the wireless communication device 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

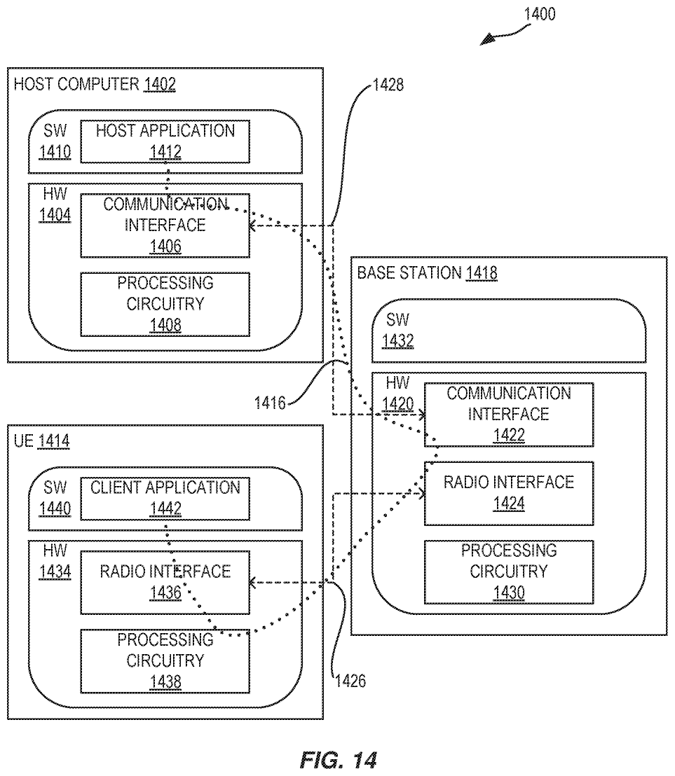

FIG. 12 is a schematic block diagram of the wireless communication device 1100 according to some other embodiments of the present disclosure. The wireless communication device 1100 includes one or more modules 1200, each of which is implemented in software. The module(s) 1200 provide the functionality of the wireless communication device 1100 described herein.

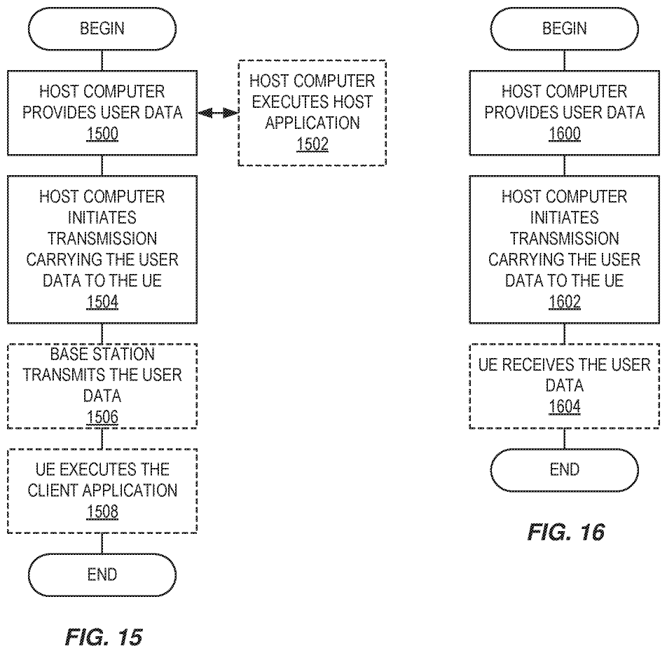

With reference to FIG. 13, in accordance with an embodiment, a communication system includes a telecommunication network 1300, such as a 3GPP-type cellular network, which comprises an access network 1302, such as a RAN, and a core network 1304. The access network 1302 comprises a plurality of base stations 1306A, 1306B, 1306C, such as Node Bs, eNBs, gNBs, or other types of wireless Access Points (APs), each defining a corresponding coverage area 1308A, 1308B, 1308C. Each base station 1306A, 1306B, 1306C is connectable to the core network 1304 over a wired or wireless connection 1310. A first UE 1312 located in coverage area 1308C is configured to wirelessly connect to, or be paged by, the corresponding base station 1306C. A second UE 1314 in coverage area 1308A is wirelessly connectable to the corresponding base station 1306A. While a plurality of UEs 1312, 1314 are illustrated in this example, the disclosed embodiments are equally applicable to a situation where a sole UE is in the coverage area or where a sole UE is connecting to the corresponding base station 1306.

The telecommunication network 1300 is itself connected to a host computer 1316, which may be embodied in the hardware and/or software of a standalone server, a cloud-implemented server, a distributed server, or as processing resources in a server farm. The host computer 1316 may be under the ownership or control of a service provider, or may be operated by the service provider or on behalf of the service provider. Connections 1318 and 1320 between the telecommunication network 1300 and the host computer 1316 may extend directly from the core network 1304 to the host computer 1316 or may go via an optional intermediate network 1322. The intermediate network 1322 may be one of, or a combination of more than one of, a public, private, or hosted network; the intermediate network 1322, if any, may be a backbone network or the Internet; in particular, the intermediate network 1322 may comprise two or more sub-networks (not shown).

The communication system of FIG. 13 as a whole enables connectivity between the connected UEs 1312, 1314 and the host computer 1316. The connectivity may be described as an Over-the-Top (OTT) connection 1324. The host computer 1316 and the connected UEs 1312, 1314 are configured to communicate data and/or signaling via the OTT connection 1324, using the access network 1302, the core network 1304, any intermediate network 1322, and possible further infrastructure (not shown) as intermediaries. The OTT connection 1324 may be transparent in the sense that the participating communication devices through which the OTT connection 1324 passes are unaware of routing of uplink and downlink communications. For example, the base station 1306 may not or need not be informed about the past routing of an incoming downlink communication with data originating from the host computer 1316 to be forwarded (e.g., handed over) to a connected UE 1312. Similarly, the base station 1306 need not be aware of the future routing of an outgoing uplink communication originating from the UE 1312 towards the host computer 1316.

Example implementations, in accordance with an embodiment, of the UE, base station, and host computer discussed in the preceding paragraphs will now be described with reference to FIG. 14. In a communication system 1400, a host computer 1402 comprises hardware 1404 including a communication interface 1406 configured to set up and maintain a wired or wireless connection with an interface of a different communication device of the communication system 1400. The host computer 1402 further comprises processing circuitry 1408, which may have storage and/or processing capabilities. In particular, the processing circuitry 1408 may comprise one or more programmable processors, ASICs, FPGAs, or combinations of these (not shown) adapted to execute instructions. The host computer 1402 further comprises software 1410, which is stored in or accessible by the host computer 1402 and executable by the processing circuitry 1408. The software 1410 includes a host application 1412. The host application 1412 may be operable to provide a service to a remote user, such as a UE 1414 connecting via an OTT connection 1416 terminating at the UE 1414 and the host computer 1402. In providing the service to the remote user, the host application 1412 may provide user data which is transmitted using the OTT connection 1416.

The communication system 1400 further includes a base station 1418 provided in a telecommunication system and comprising hardware 1420 enabling it to communicate with the host computer 1402 and with the UE 1414. The hardware 1420 may include a communication interface 1422 for setting up and maintaining a wired or wireless connection with an interface of a different communication device of the communication system 1400, as well as a radio interface 1424 for setting up and maintaining at least a wireless connection 1426 with the UE 1414 located in a coverage area (not shown in FIG. 14) served by the base station 1418. The communication interface 1422 may be configured to facilitate a connection 1428 to the host computer 1402. The connection 1428 may be direct or it may pass through a core network (not shown in FIG. 14) of the telecommunication system and/or through one or more intermediate networks outside the telecommunication system. In the embodiment shown, the hardware 1420 of the base station 1418 further includes processing circuitry 1430, which may comprise one or more programmable processors, ASICs, FPGAs, or combinations of these (not shown) adapted to execute instructions. The base station 1418 further has software 1432 stored internally or accessible via an external connection.

The communication system 1400 further includes the UE 1414 already referred to. The UE's 1414 hardware 1434 may include a radio interface 1436 configured to set up and maintain a wireless connection 1426 with a base station serving a coverage area in which the UE 1414 is currently located. The hardware 1434 of the UE 1414 further includes processing circuitry 1438, which may comprise one or more programmable processors, ASICs, FPGAs, or combinations of these (not shown) adapted to execute instructions. The UE 1414 further comprises software 1440, which is stored in or accessible by the UE 1414 and executable by the processing circuitry 1438. The software 1440 includes a client application 1442. The client application 1442 may be operable to provide a service to a human or non-human user via the UE 1414, with the support of the host computer 1402. In the host computer 1402, the executing host application 1412 may communicate with the executing client application 1442 via the OTT connection 1416 terminating at the UE 1414 and the host computer 1402. In providing the service to the user, the client application 1442 may receive request data from the host application 1412 and provide user data in response to the request data. The OTT connection 1416 may transfer both the request data and the user data. The client application 1442 may interact with the user to generate the user data that it provides.

It is noted that the host computer 1402, the base station 1418, and the UE 1414 illustrated in FIG. 14 may be similar or identical to the host computer 1316, one of the base stations 1306A, 1306B, 1306C, and one of the UEs 1312, 1314 of FIG. 13, respectively. This is to say, the inner workings of these entities may be as shown in FIG. 14 and independently, the surrounding network topology may be that of FIG. 13.

In FIG. 14, the OTT connection 1416 has been drawn abstractly to illustrate the communication between the host computer 1402 and the UE 1414 via the base station 1418 without explicit reference to any intermediary devices and the precise routing of messages via these devices. The network infrastructure may determine the routing, which may be configured to hide from the UE 1414 or from the service provider operating the host computer 1402, or both. While the OTT connection 1416 is active, the network infrastructure may further take decisions by which it dynamically changes the routing (e.g., on the basis of load balancing consideration or reconfiguration of the network).

The wireless connection 1426 between the UE 1414 and the base station 1418 is in accordance with the teachings of the embodiments described throughout this disclosure. One or more of the various embodiments improve the performance of OTT services provided to the UE 1414 using the OTT connection 1416, in which the wireless connection 1426 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1416 between the host computer 1402 and the UE 1414, in response to variations in the measurement results. The measurement procedure and/or the network functionality for reconfiguring the OTT connection 1416 may be implemented in the software 1410 and the hardware 1404 of the host computer 1402 or in the software 1440 and the hardware 1434 of the UE 1414, or both. In some embodiments, sensors (not shown) may be deployed in or in association with communication devices through which the OTT connection 1416 passes; the sensors may participate in the measurement procedure by supplying values of the monitored quantities exemplified above, or supplying values of other physical quantities from which the software 1410, 1440 may compute or estimate the monitored quantities. The reconfiguring of the OTT connection 1416 may include message format, retransmission settings, preferred routing, etc.; the reconfiguring need not affect the base station 1418, and it may be unknown or imperceptible to the base station 1418. Such procedures and functionalities may be known and practiced in the art. In certain embodiments, measurements may involve proprietary UE signaling facilitating the host computer 1402's measurements of throughput, propagation times, latency, and the like. The measurements may be implemented in that the software 1410 and 1440 causes messages to be transmitted, in particular empty or ‘dummy’ messages, using the OTT connection 1416 while it monitors propagation times, errors, etc.

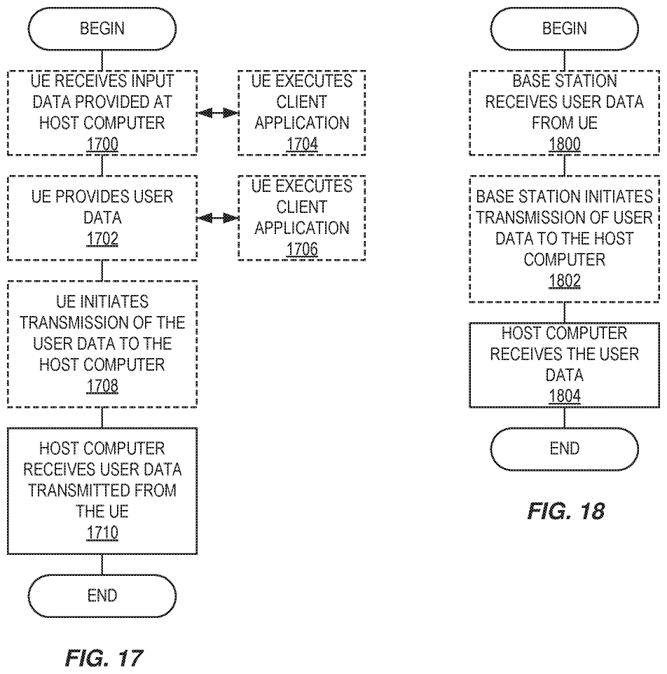

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1500, the host computer provides user data. In sub-step 1502 (which may be optional) of step 1500, the host computer provides the user data by executing a host application. In step 1504, the host computer initiates a transmission carrying the user data to the UE. In step 1506 (which may be optional), the base station transmits to the UE the user data which was carried in the transmission that the host computer initiated, in accordance with the teachings of the embodiments described throughout this disclosure. In step 1508 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1600 of the method, the host computer provides user data. In an optional sub-step (not shown) the host computer provides the user data by executing a host application. In step 1602, the host computer initiates a transmission carrying the user data to the UE. The transmission may pass via the base station, in accordance with the teachings of the embodiments described throughout this disclosure. In step 1604 (which may be optional), the UE receives the user data carried in the transmission.

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: A method performed by a wireless device for performing uplink cancellation, the method comprising one or more of: receiving (300) an indication to stop a transmission; and receiving (302) an indication to transmit on cancelled uplink resources.

Embodiment 2: The method of embodiment 1 further comprising: in response to receiving the indication to stop the transmission, performing one of: i. cancelling the transmission; and ii. muting the transmission.

Embodiment 3: The method of any of embodiments 1 to 2 wherein receiving the indication to stop the transmission comprises receiving the indication to stop the transmission from a base station.

Embodiment 4: The method of any of embodiments 1 to 3 wherein the indication to stop the transmission comprises a Downlink Control Information, DCI.

Embodiment 5: The method of any of embodiments 1 to 4 wherein the indication to transmit on cancelled uplink resources acts like a normal grant.

Embodiment 6: The method of any of embodiments 1 to 5 wherein, in response to receiving the indication to transmit on cancelled uplink resources, Listen Before Talk, LBT, may or may not be needed.

Embodiment 7: The method of embodiment 6 wherein, whether LBT is needed depends on the time-gap between the latest transmission from the base station and the cancelled uplink resources.

Embodiment 8: The method of any of embodiments 1 to 7 wherein the indication to stop the transmission is a Cancellation Indicator, CI, that indicates a Reference Resource, RR.

Embodiment 9: The method of embodiment 8 wherein any of the steps consider LBT specific procedures to make time granularity of CI more accurate.

Embodiment 10: The method of any of embodiments 8 to 9 wherein, if the RR spans over more than one Fixed Frame Period, FFP, one or several options can be applied.

Embodiment 11: The method of embodiment 10 wherein the one or several options comprises one or more of: the RR starts from the beginning of the frame period; the RR ends in the end of the current frame period; and the RR ends in the end of the current FFP minus defined IDLE period.

Embodiment 12: The method of embodiment 11 wherein the defined IDLE period is a maximum of: 100 μs and 5% of FFP or 5% of Channel Occupancy Time, COT.

Embodiment 13: The method of any of embodiments 1 to 12 wherein the indication to stop the transmission comprises a row ID of a table that is mapped (e.g., bit-map) to the resource to be cancelled indicated by the given row ID of the table.

Embodiment 14: The method of any of embodiments 1 to 13 wherein the RR excludes all pauses and gaps introduced by unlicensed operation (e.g., gaps for LBT within the COT, IDLE periods etc.).

Embodiment 15: The method of any of embodiments 1 to 13 wherein the RR includes all pauses and gaps introduced by unlicensed operation (e.g., gaps for LBT within the COT, IDLE periods etc.).

Embodiment 16: The method of embodiment 15 wherein the wireless device can know IDLE periods allocation though broadcast/unicast messaging indicating FFP configuration; and/or the wireless device can be informed about LBT gaps explicitly.

Embodiment 17: The method of any of embodiments 1 to 16 wherein the RR spans across multiple FFPs.

Embodiment 18: The method of any of embodiments 1 to 17 wherein, in response to receiving the indication stop the transmission, transmitting the transmission after cancelled resource in the same or another COT.

Embodiment 19: The method of any of embodiments 1 to 18 wherein, if the wireless device is scheduled to perform repetitions (or multi-segment transmission) and the wireless device receives CI with indicated reference resource, then one or more of the following options can happen: the repetitions which intersect the reference resource and the following repetitions will be cancelled; and all the repetitions (repetitions that intersect reference resource and the repetitions that don't intersect the reference resource) will be cancelled.

Embodiment 20: The method of any of embodiments 1 to 19 wherein the configuration of RR, including time and frequency regions and the time and frequency granularities, are adapted to the FFP or maximum COT.

Embodiment 21: The method of embodiment 20 wherein the duration of the reference region in the time domain is set to be at most equal to maximum COT in the cell.

Embodiment 22: The method of any of embodiments 1 to 21 wherein the monitoring occasions for uplink cancellation are adapted to FFP and/or Maximum Channel Occupancy Time, MCOT; e.g., IDLE periods following the MCOT are excluded from monitoring.

Embodiment 23: The method of any of embodiments 1 to 22 wherein any of these can be enabled/disabled by higher layer signaling; e.g., Radio Resource Control, RRC, or Medium Access Control, MAC, Control Element, CE, signals.

Embodiment 24: The method of any of embodiments 1 to 23 wherein the CI transmission behavior includes one or more of: CI is transmitted in the beginning of COT; CI is transmitted in the other part of the COT where the first transmission in the COT is not CI; CI is not transmitted in the Uplink, UL, symbols, or IDLE periods, or LBT gaps in the COT; CI is always transmitted in the same COT for which UL transmissions are to be cancelled, e.g., both CI transmissions and cancelled UL transmissions occur in the same COT; and CI is sent to cancel UL transmissions of successive COTs, e.g., CI transmission and cancelled UL transmissions occur in different COTs.

Embodiment 25: The method of embodiment 24 wherein, when CI is transmitted in the beginning of COT, LBT is required.

Embodiment 26: The method of any of embodiments 24 to 25 wherein, when CI is transmitted in the other part of the COT where the first transmission in the COT is not CI, LBT is not required.

Embodiment 27: The method of any of embodiments 1 to 26 wherein, in response to receiving the indication to stop the transmission, sending non-critical or deprioritize data on the remaining un-cancelled transmission resource.

Embodiment 28: The method of any of embodiments 1 to 27 wherein, if the uplink resources contain a PDU which has a critical MAC CEs, the wireless device, upon reception of such cancelling/muting signal should retrigger such control element at the next available transmission.

Embodiment 29: The method of embodiment 28 wherein the critical MAC CE is one of: a confirmation message; a Common Control Channel; a Buffering Status Report; and Power Headroom Report.

Embodiment 30: The method of any of embodiments 28 to 29 further comprising: adapting the delayed control element to suit the next transmission.

Embodiment 31: The method of any of embodiments 1 to 30 wherein, in response to receiving the indication to stop the transmission, the wireless device performs one or more of: retrigger or postpone the configuredGrantTimer, to enable more time for retransmission; restart the configuredGrantRetxTimer; and stop the configuredGrantRetxTimer, and the timer is enabled by re-transmitting in the next available grant.

Embodiment 32: The method of any of embodiments 1 to 31 wherein receiving the indication to transmit on cancelled uplink resources further comprises an indication of whether LBT needs to be performed before the resource granted for UL data transmission.

Embodiment 33: The method of any of embodiments 1 to 32 wherein receiving the indication to transmit on cancelled uplink resources further comprises an LBT category.

Embodiment 34: The method of any of embodiments 1 to 32 wherein the LBT category is agreed to in advance for cancellation cases.

Embodiment 35: The method of any of embodiments 1 to 34 wherein receiving the indication to transmit on cancelled uplink resources further comprises an indication to monitor “LBT success” signaling before the transmission on the cancelled resource.

Embodiment 36: The method of any of the previous embodiments, further comprising: providing user data; and forwarding the user data to a host computer via the transmission to the base station.

### Group B Embodiments

Embodiment 37: A method performed by a base station for enabling uplink cancellation, the method comprising: transmitting any indication of any of the Group A embodiments.

Embodiment 38: The method of any of the previous embodiments, further comprising: obtaining user data; and forwarding the user data to a host computer or a wireless device.

### Group C Embodiments

Embodiment 39: A wireless device for performing uplink cancellation, the wireless device comprising: processing circuitry configured to perform any of the steps of any of the Group A embodiments; and power supply circuitry configured to supply power to the wireless device.

Embodiment 40: A base station for enabling uplink cancellation, the base station comprising: processing circuitry configured to perform any of the steps of any of the Group B embodiments; and power supply circuitry configured to supply power to the base station.

Embodiment 41: A User Equipment, UE, for performing uplink cancellation, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 42: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 43: The communication system of the previous embodiment further including the base station.

Embodiment 44: The communication system of the previous 2 embodiments, further including the UE, wherein the UE is configured to communicate with the base station.

Embodiment 45: The communication system of the previous 3 embodiments, wherein: the processing circuitry of the host computer is configured to execute a host application, thereby providing the user data; and the UE comprises processing circuitry configured to execute a client application associated with the host application.

Embodiment 46: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 47: The method of the previous embodiment, further comprising, at the base station, transmitting the user data.

Embodiment 48: The method of the previous 2 embodiments, wherein the user data is provided at the host computer by executing a host application, the method further comprising, at the UE, executing a client application associated with the host application.

Embodiment 49: A User Equipment, UE, configured to communicate with a base station, the UE comprising a radio interface and processing circuitry configured to perform the method of the previous 3 embodiments.

Embodiment 50: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 51: The communication system of the previous embodiment, wherein the cellular network further includes a base station configured to communicate with the UE.

Embodiment 52: The communication system of the previous 2 embodiments, wherein: the processing circuitry of the host computer is configured to execute a host application, thereby providing the user data; and the UE's processing circuitry is configured to execute a client application associated with the host application.

Embodiment 53: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 54: The method of the previous embodiment, further comprising at the UE, receiving the user data from the base station.

Embodiment 55: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 56: The communication system of the previous embodiment, further including the UE.

Embodiment 57: The communication system of the previous 2 embodiments, further including the base station, wherein the base station comprises a radio interface configured to communicate with the UE and a communication interface configured to forward to the host computer the user data carried by a transmission from the UE to the base station.

Embodiment 58: The communication system of the previous 3 embodiments, wherein: the processing circuitry of the host computer is configured to execute a host application; and the UE's processing circuitry is configured to execute a client application associated with the host application, thereby providing the user data.

Embodiment 59: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 60: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 61: The method of the previous embodiment, further comprising, at the UE, providing the user data to the base station.

Embodiment 62: The method of the previous 2 embodiments, further comprising: at the UE, executing a client application, thereby providing the user data to be transmitted; and at the host computer, executing a host application associated with the client application.

Embodiment 63: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 64: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 65: The communication system of the previous embodiment further including the base station.

Embodiment 66: The communication system of the previous 2 embodiments, further including the UE, wherein the UE is configured to communicate with the base station.

Embodiment 67: The communication system of the previous 3 embodiments, wherein: the processing circuitry of the host computer is configured to execute a host application; and the UE is configured to execute a client application associated with the host application, thereby providing the user data to be received by the host computer.

Embodiment 68: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 69: The method of the previous embodiment, further comprising at the base station, receiving the user data from the UE.

Embodiment 70: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AMF Access and Mobility Function
AP Access Point
ASIC Application Specific Integrated Circuit
AUSF Authentication Server Function
CCA Clear Channel Assessment
CE Control Element
CI Cancellation Indicator
COT Channel Occupancy Time
CPU Central Processing Unit
DCI Downlink Channel Information
DL Downlink
DSP Digital Signal Processor
eNB Enhanced or Evolved Node B
FBE Frame-Based Equipment
FFP Fixed Frame Period
FPGA Field Programmable Gate Array
gNB New Radio Base Station
gNB-CU New Radio Base Station Central Unit
gNB-DU New Radio Base Station Distributed Unit
HSS Home Subscriber Server
IoT Internet of Things
IP Internet Protocol
LBE Load-Based Equipment
LBT Listen Before Talk
LTE Long Term Evolution
MAC Medium Access Control
MCOT Maximum Channel Occupancy Time
MME Mobility Management Entity
MTC Machine Type Communication
NEF Network Exposure Function
NF Network Function
NR New Radio
NRF Network Function Repository Function
NR-U NR-Unlicensed
NSSF Network Slice Selection Function
OFDM Orthogonal Frequency Division Multiplexing
OTT Over-the-Top
PC Personal Computer
PCF Policy Control Function
PDU Protocol Data Unit
P-GW Packet Data Network Gateway
PRB Physical Resource Block
PSD Power Spectral Density
RAM Random Access Memory
RAN Radio Access Network
ROM Read Only Memory
RR Reference Resource
RRC Radio Resource Control
RRH Remote Radio Head
SCEF Service Capability Exposure Function
SINR Signal to Interference and Noise Ratio
SMF Session Management Function
UDM Unified Data Management
UE User Equipment
UL Uplink
UPF User Plane Function
URLLC Ultra Reliable and Low Latency Communication

Those skilled in the art will recognize improvements and modifications to the embodiments of the present disclosure. All such improvements and modifications are considered within the scope of the concepts disclosed herein.

1. A method performed by a wireless device for performing uplink cancellation, the method comprising:
receiving an indication to stop a transmission; and
receiving an indication to transmit on cancelled uplink resources.

2. The method of claim 1, further comprising:
in response to receiving the indication to stop the transmission,
cancelling the transmission or muting the transmission.

3. The method of claim 1 wherein receiving the indication to stop the transmission comprises receiving the indication to stop the transmission from a base station.

4. The method of claim 1 wherein the indication to stop the transmission comprises Downlink Control Information (DCI).

5. The method of claim 1 wherein the indication to transmit on the cancelled uplink resources acts like a normal grant.

6. The method of claim 1 wherein, in response to receiving the indication to transmit on the cancelled uplink resources, determining whether Listen Before Talk (LBT) is needed.

7. The method of claim 6 wherein, whether LBT is needed depends on a time-gap between a latest transmission from a base station and the cancelled uplink resources.

8. The method of claim 1 wherein the indication to stop the transmission is a Cancellation Indicator, CI, that indicates a Reference Resource (RR).

9. The method of claim 8 further comprising considering LBT specific procedures to make time granularity of the CI more accurate.

10. The method of claim 8 wherein, if the RR spans over more than one Fixed Frame Period (FFP) determining to apply one or several options.

11. The method of claim 10 wherein the one or several options comprises one or more of the group consisting of:
the RR starts from a beginning of a frame period;
the RR ends in an end of a current frame period; and
the RR ends in the end of a current FFP minus a defined IDLE period.

12. (canceled)

13. The method of claim 8 wherein the indication to stop the transmission comprises a row ID of a table that is mapped to a resource to be cancelled indicated by the mapped row ID of the table.

14. The method of claim 8 wherein the RR:
excludes all pauses and gaps introduced by unlicensed operation;
includes all pauses and gaps introduced by unlicensed operation; or spans across multiple FFPs.

15. (canceled)

16. (canceled)

17. (canceled)

18. The method of claim 1 wherein, in response to receiving the indication to stop the transmission, transmitting the transmission after the cancelled uplink resource in a same or another COT.

19. The method of claim 8 wherein, if the wireless device is scheduled to perform repetitions and the wireless device receives the CI with the indicated RR, then one or more of:
repetitions which intersect the RR and following repetitions will be cancelled; and
all the repetitions will be cancelled.

20. The method of claim 8 wherein the configuration of the RR, including time and frequency regions and the time and frequency granularities, is adapted to the FFP or a Maximum COT (MCOT).

21. (canceled)

22. (canceled)

23. (canceled)

24. The method of claim 1 wherein CI transmission behavior includes one or more of:
the CI is transmitted in a beginning of a COT;
the CI is transmitted in another part of the COT where a first transmission in the COT is not the CI;
the CI is not transmitted in Uplink, UL, symbols, or the IDLE periods, or the LBT gaps in the COT;
the CI is always transmitted in the same COT for which UL transmissions are to be cancelled; and
the CI is sent to cancel the UL transmissions of successive COTs.

25. (canceled)

26. (canceled)

27. The method of claim 1 wherein, in response to receiving the indication to stop the transmission, sending non-critical or deprioritize data on a remaining un-cancelled transmission resource.

28. The method of claim 1 wherein, if the cancelled uplink resources contain a Protocol Data Unit (PDU) which has critical Medium Access Control (MAC) Control Elements (CEs) the wireless device (1100), upon reception of such cancelling/muting signal should retrigger such control element at a next available transmission.

29. (canceled)

30. (canceled)

31. The method of claim 1 wherein, in response to receiving the indication to stop the transmission, the wireless device performs one or more of:
retriggering or postponing a configuredGrantTimer, to enable more time for retransmission;
restarting a configuredGrantRetxTimer; and
stopping the configuredGrantRetxTimer, and the timer is enabled by re-transmitting in a next available grant.

32. The method of claim 1 wherein receiving the indication to transmit on the cancelled uplink resources further comprises an indication of whether LBT needs to be performed before a resource granted for UL data transmission.

33. The method of claim 1 wherein receiving the indication to transmit on cancelled uplink resources further comprises an LBT category.

34. (canceled)

35. The method of claim 1 wherein receiving the indication to transmit on cancelled uplink resources further comprises an indication to monitor “LBT success” signaling before the transmission on the cancelled resource.

36. (canceled)

37. (canceled)

38. A wireless device for performing uplink cancellation, the wireless device comprising:
one or more processors; and
memory comprising instructions to cause the wireless device to:
receive an indication to stop a transmission; and
receive an indication to transmit on cancelled uplink resources.

39. (canceled)

40. (canceled)

41. (canceled)
